(19) United States
(12) Patent Application Publication
(10) Pub. No.: US 2005/0229950 A1
(43) Pub. Date: Oct. 20, 2005

(54) Brush positioning device for a wafer cleaning station

(76) Inventors: Ming-Chun Chou, Vancouver, WA (US); Brian Wade Petersen, Vancouver, WA (US)

Correspondence Address: DUANE MORRIS, LLP;IP DEPARTMENT, ONE LIBERTY PLACE, PHILADELPHIA, PA, 19103-7396, US

(21) Appl. No.: 10/823,955

(22) Filed: Apr. 14, 2004

(51) Int. Cl. C23G 1/00; B08B 7/00

(52) U.S. Cl. 134/18; 134/6; 134/2; 134/33; 134/56 R; 134/137

(57) ABSTRACT

A method, device, and system for positioning a brush of a wafer cleaning system. In the method, device, and system one or more light sources are positioned to generate one or more light beams across a plane. One or more light detectors are positioned to detect when the light beams are interrupted by the brush as it advances toward the plane.

### FIELD OF THE INVENTION

The present invention relates to wafer cleaning systems used in semiconductor manufacturing, and more particularly, to a brush positioning device for a wafer cleaning system.

### BACKGROUND OF THE INVENTION

Dust and dirt particles often find their way to semiconductor wafers during semiconductor device fabrication. These contaminants may degrade the reliability of the semiconductor devices or cause fabrication difficulties. Accordingly, various wafer cleaning systems have been developed to clean contaminants from the semiconductor wafers during semiconductor device fabrication.

Typical wafer cleaning systems employ a rotary brush, the end or ends of which are brought into contact with the surface of the wafer, and a cleaning agent, such as ammonium hydroxide and deionized water, to clean the surfaces of the semiconductor wafers during semiconductor device fabrication. The cleaning agent is applied over the surface of the semiconductor wafer as the rotary brush scrubs the surface of the wafer. During scrubbing, the semiconductor wafer is rotated so that the particle contaminants, which become suspended in the cleaning agent during scrubbing, flow over the peripheral edge of the wafer, and thus, are removed from the wafer.

As mentioned above, the rotary brush is brought into contact with the surface of the wafer. The contact with the surface of the semiconductor wafer must be optimize to ensure proper cleaning of the wafers. Proper contact is accomplished by adjusting the distance (the brush-to-wafer distance or brush height) between the end of the brush and the semiconductor wafer to be cleaned to approximately zero millimeters. This distance usually needs to be checked and readjusted when a worn-out brush is replaced by a new one or when wafers of different film thickness are cleaned.

The checking and adjustment of the brush-to-wafer distance is typically accomplished by performing a brush height calibration procedure. Current brush height calibration procedures are usually performed manually, by a technician or the operator of the wafer cleaning system. During such a calibration procedure, the technician or operator visually checks the contact between the brush and the surface of the wafer and manually adjusts the height of the brush, i.e., the brush-to-wafer distance to approximately zero millimeters in order to optimize brush contact with the surface of the wafer to be cleaned.

The aforementioned brush height calibration procedure is time consuming because it requires repeated checks to ensure optimal contact between the brush and the surface of the wafer. In addition, the technician or operator must be skillful in deciding the “zero distance point,” which is somewhat subjective and usually varies from technician to technician. Hence, no standard specification can be followed.

### SUMMARY OF THE INVENTION

A method, device, and system is disclosed which relates to the positioning of a brush of a wafer cleaning system. More specifically, at least one light source is positioned to generate at least one light beam across a plane. At least one light detector is positioned to detect when the light beam is interrupted by the brush.

### BRIEF DESCRIPTION OF THE DRAWINGS

FIG. 1 is a schematic view of an embodiment of a semiconductor wafer wet cleaning system.

FIG. 2 is a perspective view of a pivoting brush arm of the semiconductor wafer wet cleaning system shown in FIG. 1.

FIG. 3A is a perspective view and FIG. 3B is an elevational view of a brush assembly of the semiconductor wafer wet cleaning system of FIG. 1.

FIG. 4 is a top view and FIG. 5 is an elevational view of an exemplary embodiment of a brush positioning or calibration device for a semiconductor wafer wet cleaning system such as the system illustrated in FIG. 1.

FIGS. 6 and 7 are elevational views of the brush positioning or calibration device illustrating the operation thereof.

### DETAILED DESCRIPTION OF THE INVENTION

The present invention is an automatic brush positioning (or brush position calibration) device for a wafer cleaning system and a wafer cleaning system which incorporates same. The present invention utilizes one or more lasers to check and adjust the brush height or brush-to-wafer distance.

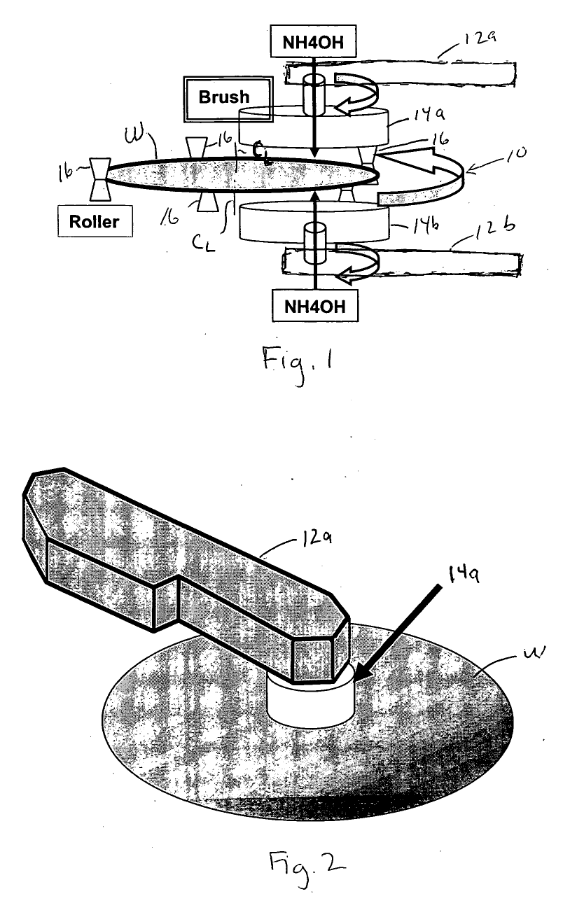

Referring to FIG. 1, there is shown an illustrative embodiment of a semiconductor wafer wet cleaning system. The wafer wet cleaning system comprises a stage (not shown) which includes a wafer rotating mechanism 10, one or, as shown, two pivoting brush arms 12a and 12b (FIG. 2 illustrates one of the brush arms) that are each advanced away or toward respective surfaces of a semiconductor wafer W to be cleaned, by a stepper motor or like mechanism, and a brush assembly 14a and 14b mounted at an end of each respective brush arm 12a and 12b. In the shown embodiment, the wafer rotating mechanism 10 comprises a plurality rollers 16, which are configured to engage a peripheral edge of the wafer W so as to support and rotate the wafer W around its central axis C_{L}. In an alternative embodiment of the invention, for example, where only one pivoting brush arm is utilized, the wafer rotating mechanism may comprise a rotating turntable or chuck (not shown) on which the wafer W is mounted and rotated.

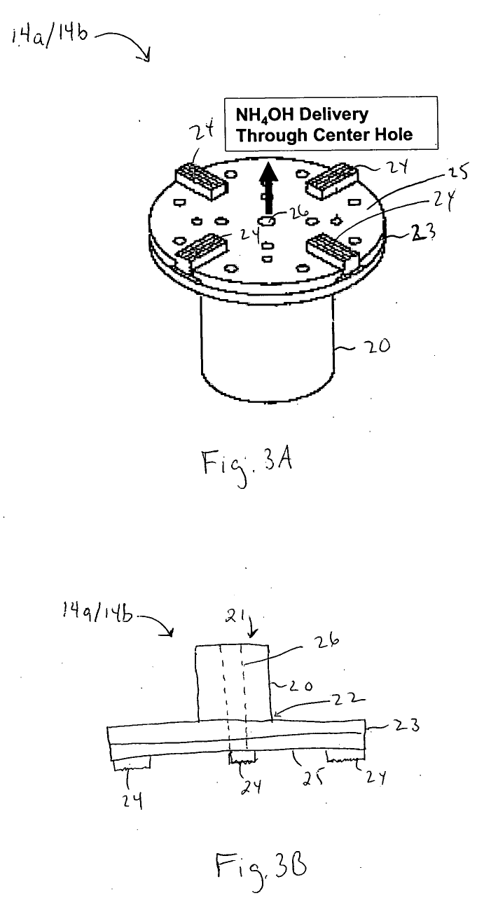

As collectively illustrated in FIGS. 3A and 3B, each brush assembly 14a and 14b may comprise a cylindrical drive member 20 having a first end 21 that attaches to a drive mechanism contained within its associated brush arm 12a and 12b, and a second end 22 attached to a central portion of a disc member 23. One or more brushes 24 may be mounted on working surface 25 of the disc member 23, adjacent the peripheral edge thereof. The brushes 24 may be made of a polymeric material, such as poly(vinyl acetate). A centrally located channel or conduit 26 extends through the drive member 20 and disc member 23. The conduit 26 delivers a cleaning agent, such as ammonium hydroxide and deionized water, channeled through the brush assembly's respective brush arm 12a and 12b, to the surface of the semiconductor wafer W to be cleaned.

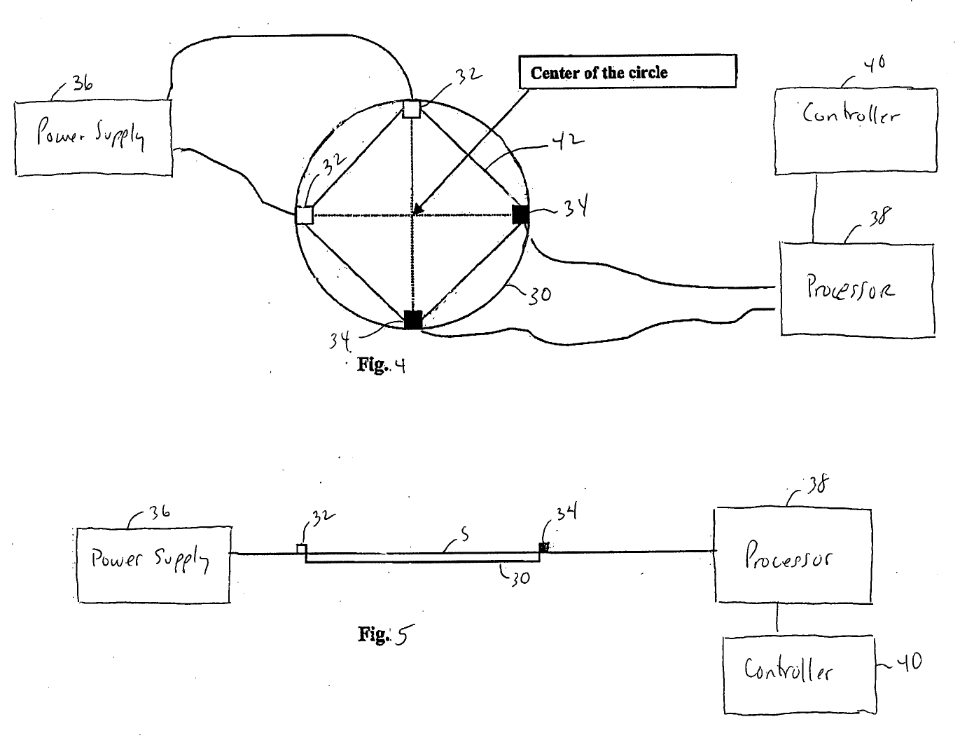

FIGS. 4 and 5 collectively illustrate an exemplary embodiment of the brush positioning or calibration (ABP) device of the present invention, which may be utilized with the wafer cleaning system described above. For purposes of clarity only, the ABP device is described with respect to only one of the pivoting arms/brush assemblies of the wafer cleaning system. One of ordinary skill in the art will recognize that the ABP device may be adapted for use with both pivoting brush arms/brush assemblies of the wafer cleaning system. The ABP device comprises a wafer-like brush height calibration unit 30, one or more light sources 32 and one or more corresponding light detectors 34, a power supply 36 for the one or more light sources 32, a processor 38 in communication with the light detectors 34, and a controller 40 in communication with the processor 38. The diameter of the calibration unit 30 may be substantially identical to the diameter of the wafer or wafers to be cleaned so that it can be mounted between the wafer rollers 16 (not required if a rotary chuck is utilized). The one or more light sources 32 and one or more corresponding light detectors 34 may be detachably or permanently positioned on the top surface of the calibration unit 30. A frame assembly 42 may be provided to fix the positions of the light sources 32 and light detectors 34 relative to one another. Alternatively, the light source(s) 32 and light detector(s) 34 may be detachably or permanently positioned on the stage so that they are adjacent the peripheral edge of the calibration unit 30. The light sources 32 and light detectors 34 are disposed such that each light detector is about 180 degrees across (the calibration unit 30) from its corresponding light source 32. Each light source 32 and corresponding light detector 34 are disposed in the same plane (i.e., at the same height), such that the light emitted from the light source 32 is projected across a plane substantially corresponding to the surface S of the calibration unit 30. The use of more than one light source and detector allows for the determination of whether the brush arm or wafer support surface (defined by the rollers or chuck) is level.

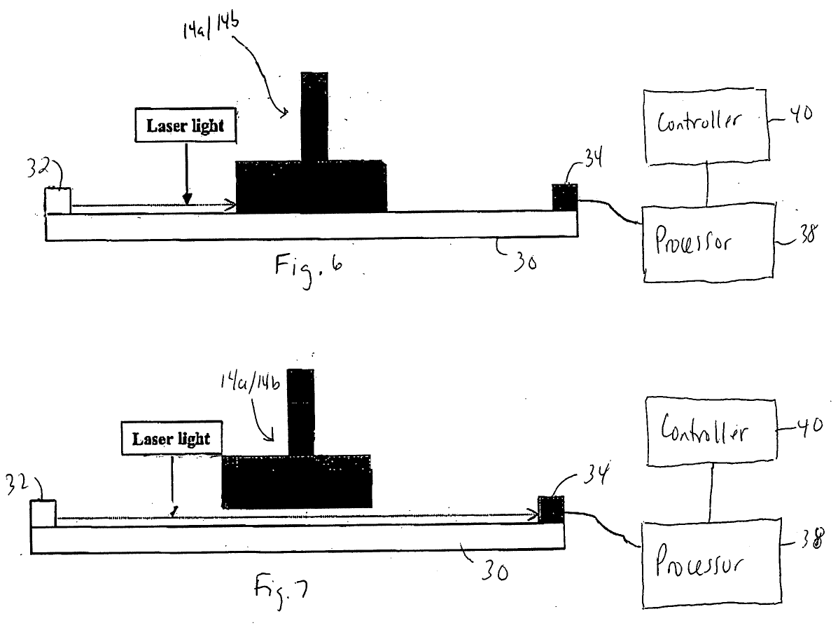

Referring to FIGS. 6 and 7, an automatic mode of operation will be described. In the automatic operational mode, the calibration unit 30 may be constructed to have substantially the same thickness as the wafers to be cleaned. Accordingly, a plurality of calibration units 30 having a range of different thicknesses may be provided. The calibration unit 30 is positioned on wafer rotating mechanism 10 (FIG. 1) and the one or more light sources 32 are activated. The one or more light detectors 34 sense the light of their corresponding light sources 32 and send light sensing signals to the processor 38. The processor 38 processes the light sensing signals and outputs a first processor signal to the controller 40. In response thereto, the controller 40 sends a first control signal that causes the pivoting brush arm 12a/12b to advance the brush assembly 14a/14b toward the surface S of the calibration wafer 30. When the cleaning ends of the brushes 24 of the brush assembly 14a/14b interrupt the light beam (just as the cleaning ends of the brush contact the plane, i.e., the surface of the calibration unit 30), the light detectors 34 stop sending the light sensing signals to the processor 38. Alternatively, each of the light detectors 34 may send a no light sensing signal to the processor 38 when the cleaning ends of the brushes 24 interrupt the light beams. The processor 38 processes the sudden absence of the light sensing signals or the no light sensing signals and outputs a second processor signal to the controller 40. In response thereto, the controller 40 to sends a second control signal that immediately causes the pivoting brush arm to stop advancing the brush assembly 14a/14b toward the surface S of the calibration unit 30. The processor 38 may then store this brush height or brush-to-wafer distance data for use with the wafer or wafers to be cleaned with this brush height setting. In embodiments having multiple light source and detectors, the processor 38 can also determine the levelness of the brush arm and/or wafer support surface based on whether all of the light beams have been interrupted at the same time by the cleaning ends of the brush 24. If all the light beams are not interrupted at the same time, an indicator light provided on the controller 40, for example, can be activated.

Referring still to FIGS. 6 and 7, a manual mode of operation will be described. In the manual operational mode, the thickness of the calibration unit 30 and the thickness of the wafers to be cleaned are both converted to stepper motor counts (the counts of the stepper motors that advance the brush arms 12a and 12b). For example, if every 0.010 inch of up or down brush arm movement requires 10 stepper motor counts, a calibration unit having a thickness T of 0.1000 inches would convert to a stepper motor count of 100 counts and a wafer having a thickness of 0.050 inches would convert to a stepper motor count of 50 counts.

The calibration unit 30 is then positioned on wafer rotating mechanism 10 (FIG. 1) and the one or more light sources 32 are activated. The one or more light detectors 34 sense the light of their corresponding light sources 32 and send light sensing signals to the processor 38. The processor 38 processes the light sensing signals and outputs a first processor signal to the controller 40. In response thereto, the controller 40 activates one or more indicator lights (not shown but may be on the controller), that allow visual monitoring of each light source/detector arrangement to indicate when the light beams generated by the light sources 32 have been broken by the brush. The pivoting brush arm 12a/12b is then manually activated, via the controller 40, to advance the brush assembly 14a/14b toward the surface S of the calibration unit 30. When the cleaning ends of the brushes 24 of the brush assembly 14a/14b interrupt the light beam Oust as the cleaning ends of the brush contact the plane, i.e., the surface of the calibration unit 30), the light detectors 34 cease sending the light sensing signals to the processor 38, which causes the one or more lights to be deactivated. In immediate response thereto, the pivoting brush arm is manually deactivated, via the controller 40, to stop the advancing of the brush assembly 14a/14b toward the surface S of the calibration unit 30. The stepper motor count (of the brush arm stepper motor), when the one or more lights are deactivated, is then obtained from the controller 40.

The brush height may be calculated by adding the brush arm stepper motor count at light deactivation to the difference between the calibration unit thickness stepper motor count and the wafer thickness stepper motor count. For example, if the stepper motor count at light deactivation is 1000, the calibration unit thickness stepper motor count is 100, and the wafer thickness stepper motor count is 50, the brush height would be equal to 1050 stepper motor counts; i.e., 1000+(100−50). Accordingly, the controller would be set to stop the brush arm at 1050 stepper motor counts.

In embodiments having multiple light source and detectors, the levelness of the brush arm and/or wafer support surface can be determined by observing whether all of the light indicators are deactivated at the same time when the brush is moved toward the surface S of the calibration unit.

In one embodiment, the one or more light sources 32 of the ABP device may comprise lasers that generate continuous pulses of light. Laser light provides a steady and strong signal that allows easy detection of any obstacle in the path of the light. The one or more light detectors 34 of the ABP device may comprise laser detectors capable of sending signals.

In an alternative embodiment of the ABP device, the calibration wafers may be omitted. This is possible because the semiconductor wafers of a given lot typically have the same thickness. Hence, the brush height may be adjusted with respect to a first wafer of the lot, and the brush height set for the first wafer can be used for the rest of the wafers of the that lot, eliminating the need for the calibration wafers.

While the foregoing invention has been described with reference to the above, various modifications and changes can be made without departing from the spirit of the invention. Accordingly, all such modifications and changes are considered to be within the scope of the appended claims.

1. A device for positioning a brush of a wafer cleaning system, the device comprising:
at least one light source positioned to generate at least one light beam across a plane; and
at least one light detector positioned to detect the at least one light beam;
wherein when the brush contacts the plane, the at least one light beam is interrupted by the brush.

2. The device of claim 1, wherein the at least one light detector generates a first indication if the at least one light beam is not interrupted by the brush, and a second indication if the at least one light beam is interrupted by the brush.

3. The device of claim 2, further comprising a processor for processing the first and second indications.

4. The device of claim 3, further comprising a controller responsive to the processor for automatically stopping the brush when the brush interrupts the at least one light beam.

5. The device of claim 1, further comprising a controller for automatically stopping the brush when the brush interrupts the at least one light beam.

6. The device of claim 3, further comprising a controller for manually stopping the brush when the brush interrupts the at least one light beam.

7. The device of claim 1, further comprising a controller for manually stopping the brush when the brush interrupts the at least one light beam.

8. The device of claim 1, further comprising at least one indicator light for indicating when the at least one light beam has been interrupted by the brush.

9. The device of claim 1, further comprising a calibration unit having a surface that defines the plane.

10. The device of claim 9, wherein the at least one light source and the at least one light detector are disposed on the surface of the calibration unit.

11. A wafer cleaning system comprising:
a wafer rotating mechanism;
a brush;
at least one light source positioned to generate at least one light beam across a plane; and
at least one light detector positioned to detect the at least one light beam;
wherein when the brush contacts the plane, the at least one light beam is interrupted by the brush.

12. The system of claim 11, wherein the at least one light detector generates a first indication if the at least one light beam is not interrupted by the brush, and a second indication if the at least one light beam is interrupted by the brush.

13. The system of claim 12, further comprising a processor for processing the first and second indications.

14. The system of claim 13, further comprising a controller responsive to the processor for automatically stopping the brush when the brush interrupts the at least one light beam.

15. The system of claim 11, further comprising a controller for automatically stopping the brush when the brush interrupts the at least one light beam.

16. The system of claim 13, further comprising a controller for manually stopping the brush when the brush interrupts the at least one light beam.

17. The system of claim 11, further comprising a controller for manually stopping the brush when the brush interrupts the at least one light beam.

18. The system of claim 11, further comprising at least one indicator light for indicating when the at least one light beam has been interrupted by the brush.

19. The system of claim 1 1, further comprising a calibration unit having a surface that defines the plane.

20. The system of claim 19, wherein the at least one light source and the at least one light detector are disposed on the surface of the calibration unit.

21. A method of positioning a brush of a wafer cleaning system, the method comprising the steps of:
generating a light beam across a plane;
advancing the brush toward the plane;
generating a first signal if the light beam is detected across the plane;
generating a second signal if the light beam is not detected across the plane; and
stopping the brush in response to the second signal.

22. A method of positioning a brush of a wafer cleaning system, the method comprising the steps of:
generating a light beam across a plane;
advancing the brush toward the plane;
generating a first signal if the light beam is detected across the plane;
generating a second signal if the light beam is not detected across the plane;
stopping the brush in response to the second signal; and
calculating a position of the brush from information associated with the stopping of the brush.
